(19) United States
(12) Patent Application Publication
(10) Pub. No.: US 2025/0349529 A1
(43) Pub. Date: Nov. 13, 2025

(54) Ion Optical Elements and Methods of Manufacturing the Same

(71) Applicant: DH Technologies Development Pte. Ltd., Singapore (SG)

(72) Inventors: Aaron Timothy BOOY, Barrie (CA); Robert HAUFLER, Toronto (CA)

(21) Appl. No.: 18/707,137

(22) PCT Filed: Nov. 7, 2022
(86) PCT No.: PCT/IB2022/060696

§ 371 Date: May 2, 2024

Related U.S. Application Data
(60) Provisional application No. 63/276,801, filed on Nov. 8, 2021.

(51) Int. Cl. H01J 49/06; H01J 49/40

(52) U.S. Cl. CPC H01J 49/068; H01J 49/405

(57) ABSTRACT

Ion optical elements in accordance with various aspects of the present teachings can, in various embodiments, be utilized to replace conventional stacked-ring ion optical elements (e.g., ion guides, ion tunnels, ion funnels, reflectrons), which typically contain a plurality of individual conductor rings and insulating spacers that must be manufactured with exacting tolerances and precisely aligned during assembly. In various aspects, methods of producing ion optical elements are also disclosed herein, which according to various aspects may reduce the cost and/or complexity associated with precisely manufacturing and assembling the many parts of conventional stacked-ring devices.

### FIELD

The present teachings generally relate to ion optical elements and methods of manufacturing the same for use in a mass spectrometry (MS) system.

### BACKGROUND

Mass spectrometry (MS) is an analytical technique for measuring the mass-to-charge ratios (m/z) of molecules within a sample, with both quantitative and qualitative applications. For example, mass spectrometry can be used to identify unknown compounds in a test substance, determine the isotopic composition of elements in a specific molecule, determine the structure of a particular compound by observing its fragmentation, and/or quantify the amount of a particular compound in a test sample. MS typically involves converting the sample molecules into ions using an ion source and separating and detecting the ionized molecules with electric and/or magnetic fields due to differences in their mass-to-charge ratios (m/z) using one or more mass analyzers.

In MS, ion optical elements generate an electric field for effecting ion motion such as by converging, accelerating, or decelerating ions, bending the trajectory of ions, and selecting specific ions while diverging others. For example, in time-of-flight mass spectrometry (ToF-MS), a type of ion optical element commonly referred to as an ion mirror or reflectron may be used to reverse the ions' trajectory to help compensate for any initial kinetic energy distribution of the injected ions by focusing the ions of a particular m/z at a common kinetic energy. For example, higher energy ions will travel deeper within the ion mirror before having their trajectories reversed, thereby increasing their path length and decreasing the energy spread between ions of a particular m/z.

Conventionally, ion optical elements such as ion mirrors are constructed by stacking a plurality of conductive rings, each ring being separated from an adjacent ring by an insulator such that a predetermined electric potential (voltage) can be separately applied to each ring in order to create a desired field within the stacked-ring structure. Such ion mirrors may also include one or more plates or grids to terminate the electric field (e.g., at the region in which the ions enter and exit the ion mirror) or to help separate the fields generated by the stages of a dual-stage reflectron. The construction of such stacked-ring optical elements can be complex and costly, as they require the precise alignment and spacing of many parts.

There remains a need for improved ion optical elements such as ion mirrors for use in a MS system.

### SUMMARY

The present teachings are generally directed to ion optical elements and methods of manufacturing the same. In certain aspects, the ion optical element may be an ion mirror for use in a ToF-MS system.

Production of conventional stacked-ring ion optical elements requires exacting alignment and spacing when stacking a plurality of precisely machined, electrically isolated, conductor rings with high precision insulating spacers. Indeed, as ion optical elements such as ion mirrors have become longer and/or provided for multiple reflections, tolerances must be even more tightly controlled as an increasing number of components are added to the stacked-ring structures. The incorporation of grids into conventional ion mirrors also adds to manufacturing cost and complexity. For example, grids are typically manufactured independently from the other components (with similar tight tolerances), and care must be taken during final assembly with the other components of the ion mirror to ensure that the grids remain flat so as not to distort the electric fields within the ion mirror, which can lead to ion scattering and decreased resolution.

Certain examples of ion optical elements described herein may not only comprise fewer parts than conventional stacked-ring structures, but may also reduce the cost and time associated with precisely machining and assembling the various components of such a conventional ion optical element.

In accordance with various aspects of the present teachings, an ion optical element is provided, the ion optical element comprising an insulating substrate having an inner channel bounded by an inner surface of the insulating substrate and extending along an axis from a first end to a second end thereof. A resistive coil is coupled to the inner surface and continuously extends from the first end to the second end of the insulating substrate such that the application of a voltage differential across the resistive coil is configured to generate an electric field within the channel for controlling axial motion of ions therein.

In various aspects, the resistive coil may comprise a plurality of revolutions about the channel, with each revolution being separated from an adjacent revolution by uncoated portions of the insulating substrate. Alternatively, in some aspects, each revolution may be separated from an adjacent revolution by a relatively higher resistivity coating.

The resistive coil may be coupled to the inner surface of the insulating substrate in a variety of manners. By way of example, the resistive coil may comprise a resistive coating formed on the inner surface of the insulating substrate.

In various aspects, the electric field generated by the resistive coil when applying a voltage differential thereacross can have a variety of configurations. By way of non-limiting example, in some aspects, the resistive coil may be configured such that the gradient of the field along the axis of the inner channel can be linear or non-linear. For example, in certain aspects, the resistive coil may exhibit substantially consistent spacing, pitch, thickness, and resistivity along its length as it extends from one end of the insulating substrate to the other. In such aspects, when a first end of the resistive coil adjacent the first end of the insulating substrate is maintained at a first DC potential and the second end of the resistive coil adjacent the second end of the insulating substrate is maintained at a second DC potential, the gradient of the electric field may be substantially linear along the axis of the inner channel. In some additional or alternative aspects, the electric field may be modified by modifying one or more of the spacing, pitch, thickness, and resistivity of portions of the resistive coil. By way of non-limiting example, a coil exhibiting variable spacing between adjacent coil turns may exhibit a non-linear gradient.

In certain aspects, the ion optical element comprises a time-of-flight ion mirror and at least one DC voltage source may be coupled to the resistive coating. By way of example, an electrical contact at one end of the resistive coating may have a DC potential applied thereto while the other end of the resistive coating may be grounded. The ion mirror can be a one-stage or a two-stage mirror. For example, in some aspects, the insulating substrate can be one stage of a two-stage mirror. Additionally, in certain aspects, the ion mirror can further comprise a second insulating substrate having an inner channel extending along an axis from a first end of the second insulating substrate to a second end of the second insulating substrate, wherein the channel of the second insulating substrate is configured to allow passage of ions therein. A second resistive coil can be coupled to the inner surface of the second insulating substrate and can maintain a second voltage differential thereacross so as to generate a different electric field within the inner channel of the second insulating substrate. In such aspects, the channels of the first insulating substrate and the second insulating substrate can be aligned so as to allow passage of ions between the channels of the first and second substrates.

In certain related aspects, a middle grid of conductive elements can extend across a passageway between the inner channels of the first and second insulating substrates. Optionally, an entrance grid may be disposed adjacent the first end of the first insulating substrate. Additionally, in certain aspects, a mirror plate may be disposed adjacent the second end of the second insulating substrate.

In various aspects, the channel and inner surface can have a variety of configurations. For example, the cross-sectional area can have a variety of shapes including rectangular and circular. Additionally, in certain aspects, surface features can be formed on the inner surface of the insulating substrate. In some example aspects, the inner surface can comprise at least one inwardly-extending projection extending from the first end to the second end of the insulating substrate, wherein the resistive coating is formed on at least an innermost surface of the at least one projection. By way of example, the projection can comprise a spiral, as in the thread of a nut.

In various related aspects, the resistive coil can be coupled to the surface of the projection such that each turn of the coil is separated from other portions of the resistive coil by uncoated insulating substrate or differently coated substrate. In some aspects, the resistive coil may comprise a resistive coating formed on at least an innermost surface of the plurality of projections.

The insulating substrate can be a variety of materials and may generally be configured so as to not conduct electricity under normal operating conditions of the ion optical element. By way of example, the insulating substrate may exhibit a conductivity less than about 0.001 S/m. In various aspects, the insulating substrate may comprise one of ceramic, polymers, silicon, and glass.

The resistive coil may have a variety of resistivities. As will be appreciated in light of the present teachings, the resistivity of the resistive coil may be selected to operate with the one or more power supplies to which the resistive coil is coupled. In some example aspects, the resistive coil may exhibit a total resistance between the first and second ends of the insulating substrate in a range from about 1MΩ to about 1GΩ. For example, the resistive coil may exhibit a resistance between the first and second ends of the insulating substrate less than about 100 MΩ.

The resistive coil may also comprise a variety of materials and/or may be formed on the inner surface using a variety of techniques. For example, in certain aspects, the resistive coil may comprise a mixture of a polymer and conductive particles that may be applied (e.g., printed) on the inner surface. Alternatively, in some example aspects, the resistive coating may be formed by atomic layer deposition.

In accordance with various aspects of the present teachings, methods of manufacturing an ion optical element are provided. For example, in some aspects, a method is provided comprising forming a substrate from an insulator material, the substrate having an inner channel bounded by an inner surface of the insulating substrate and extending along an axis from a first end to a second end thereof. The method may also comprise coupling a resistive coil to an inner surface bounding an inner channel of an insulating substrate, wherein maintaining a voltage differential across the resistive coil is configured to generate an electric field within the channel for controlling axial motion of ions therein.

The resistive coil may be formed on the inner surface of the substrate in a variety of manners. By way of example, the resistive coil may be formed on the inner surface of the substrate by atomic layer deposition. Alternatively, in some aspects, the resistive coil may be formed on the inner surface of the substrate by applying a resistive ink to the inner surface of the channel.

In various aspects, the method may further comprise forming at least one projection on the inner surface of the substrate. For example, in some related aspects, the at least one projection may be formed by removing portions of the insulating substrate.

In certain aspects, the insulating substrate may be a first insulating substrate, and the method may further comprise coupling the first insulating substrate to a second insulating substrate having a resistive coil formed on at least a surface portion of an inner channel of the second insulating substrate. The first and second insulating substrates may be aligned so as to allow passage of ions between the inner channels of the first and second insulating substrates.

Additionally or alternatively, methods of manufacturing in accordance with various aspects of the present teachings may comprise wrapping at least one wire around an insulating substrate so as to dispose a plurality of wire portions across a first end and a second of the insulating substrate, wherein the insulating substrate comprises an inner channel extending along an axis from the first end to the second end and bounded by an inner surface of the insulating substrate. The method may also comprise bonding the plurality of wire portions to at least one of the first end and the second end of the insulating substrate.

In certain related aspects, the method may further comprise cutting the at least one wire so as to remove at least a section of the at least one wire extending between the first and second ends of the insulating substrate.

In a related aspect, an ion optic assembly for use in a mass spectrometer is disclosed, which comprises a first ion optic extending from a proximal end to a distal end, said first ion optic having a lumen providing a first ion passageway and a first resistive trace disposed on an inner surface of the lumen, wherein flow of a current through the first resistive trace establishes a first electric field within the first ion passageway, and a second ion optic extending from a proximal end to a distal end, wherein the proximal end of the second ion optic can be coupled to the distal end of the first ion optic to form said ion optic assembly, said second ion optic further comprising a lumen providing an ion passageway and a second resistive trace disposed on an inner surface of the lumen, wherein flow of a current through said second resistive trace establishes a second electric field within the second ion passageway. A conductive grid is positioned between said ion optics and configured to be maintained at a reference electric potential such that said first and second electric fields terminate on said conductive grid.

In some embodiments, a first metal coating is deposited on a proximal surface of the first ion optic and a second metal coating is deposited on a distal surface of the second ion optic. The optic assembly can include a first conductive tab for providing a conductive path between the first resistive trace and said first metal coating. In addition, the optic assembly can also include a second conductive tab for providing a conductive path between the second resistive trace and the second metal coating.

These and other features of the applicant's teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIGS. 1A-B are a schematic representation of an exemplary ion optical element in accordance with an aspect of various embodiments of the applicant's teachings.

FIG. 2 is a schematic representation of the ion optical element of FIGS. 1A-B as a time-of-flight ion mirror in accordance with an aspect of various embodiments of the applicant's teachings.

FIG. 3 is a schematic representation of another exemplary ion optical element in accordance with an aspect of various embodiments of the applicant's teachings.

FIG. 4 is a schematic representation of another exemplary ion optical element in accordance with an aspect of various embodiments of the applicant's teachings.

FIG. 5 is a schematic representation of another ion optical element as a dual-stage time-of-flight ion mirror in accordance with an aspect of various embodiments of the applicant's teachings.

FIGS. 6A-D depicts various example steps in manufacturing an ion optical element for use as an mirror in accordance with an aspect of various embodiments of the applicant's teachings.

FIG. 7 is a schematic representation of a dual-stage ion mirror assembly accordance with an aspect of various embodiments of the applicant's teachings.

FIGS. 8A-B are schematic representations of another exemplary ion optical element in accordance with an aspect of various embodiments of the applicant's teachings.

FIG. 9 is a schematic representation of another exemplary ion optical element in accordance with an aspect of various embodiments of the applicant's teachings.

FIG. 10 is a schematic representation of another exemplary ion optical element in accordance with an aspect of various embodiments of the applicant's teachings.

FIGS. 11A-B is a schematic representation of another exemplary ion optical element in accordance with an aspect of various embodiments of the applicant's teachings

FIG. 12A schematically depicts an ion optic assembly for use in a mass spectrometric system, where the ion optic assembly includes two ion optic components coupled to one another,

FIG. 12B schematically illustrates the ion optic components of the ion optic assembly depicted in FIG. 12A as separate components,

FIG. 13A is a top schematic perspective view of one of the ion optics illustrating an electrically resistive trace deposited on an inner surface thereof,

FIG. 13B is a bottom schematic perspective view of the ion optic illustrated in FIG. 13A,

FIGS. 14A and 14B schematically depict a conductive tab employed in the ion optic depicted in FIGS. 13A/13B for providing electrical connection between an end of the electrically resistive trace deposited on the inner surface of the ion optic and a metal layer deposited on an end surface of the ion optic,

FIG. 15A is a schematic perspective view of the other ion optic of the ion optic assembly, illustrating an electrically resistive trace deposited on an inner surface thereof,

FIG. 15B and its inset schematically depict an electrically conductive tab utilized for electrically connecting the resistive trace shown in FIG. 15A to a top metalized surface of the ion optic,

FIGS. 16A and 16B schematically illustrate metal grids positioned on the proximal and distal surfaces of the ion optic depicted in FIGS. 13A and 13B,

FIG. 17A schematically depicts the ion optic assembly, illustrating that in this embodiment the middle grid is maintained at electric ground and appropriate voltages are applied to a proximal metal grid of one of the ion optics that initially receives the ions and a mirror plate of the other ion optic so as to allow the ion optic assembly to function as an ion mirror suitable for use in a mass spectrometric system, and

FIG. 17B is an equivalent circuit diagram associated with an ion optic assembly in accordance with an embodiment of the present teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein mean 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

Ion optical elements in accordance with various aspects of the present teachings can, in various embodiments, be utilized to replace conventional stacked-ring ion optical elements (e.g., ion guides, ion tunnels, ion funnels, reflectrons), which typically contain a plurality of individual conductor rings and insulating spacers that must be manufactured with exacting tolerances and precisely aligned during assembly. In various aspects, methods of producing ion optical elements are also disclosed herein, which according to various aspects may reduce the cost and/or complexity associated with precisely manufacturing and assembling the many parts of conventional stacked-ring devices.

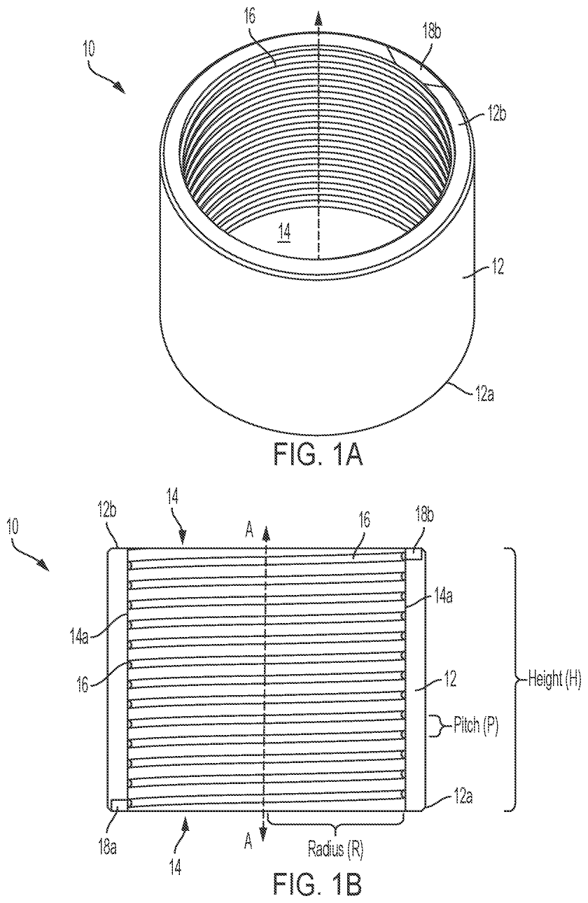

With reference now to FIGS. 1A-B, an example ion optical element 10 for controlling the path of charged particles (e.g., ions) according to various aspects of the present teachings is depicted in perspective and cross-sectional views. As shown, the ion optical element comprises a body or substrate 12 extending longitudinally from a first end 12a to a second end 12b. The substrate 12 defines an inner channel 14 extending along an axis (A) and having an opening at each of the first and second ends 12a,b of the substrate 12 through which ions may enter and/or exit the inner channel 14 as discussed otherwise herein. As shown in FIGS. 1A-B, the inner channel 14 comprises a straight passageway such that ions are generally directed longitudinally along the axis A. As discussed in detail below, for example, when ion optical element 10 is configured as a time-of-flight ion mirror, ions may both enter and exit the ion mirror at one end of the channel 14 (e.g., adjacent first end 12a) due to the generation of an electric field by electrical traces 16 within ion optical element 10 that may decelerate and/or reverse the trajectory of the entering ions generated.

A person skilled in the art will appreciate that the present teachings are not so limited, however, and that the inner channel 14 may have a variety of configurations to cause the trajectory of ions to be modified as desired. By way of example, an ion optical element may utilize an inner channel that curves along a central axis for bending the trajectory of an ion beam transmitted therethrough. Likewise, though FIGS. 1A-B depict an example ion optical element 10 in which the inner surface generally extends parallel along the longitudinal axis (A) of the substrate 12, an ion optical element according to the present teachings may be configured for use as an ion funnel for focusing the ions, for example, by providing an inner channel that narrows in the direction of travel of the ions. In other words, the inner channel may exhibit a decreasing cross-sectional area along its length such that the distance of the inner surface from the central axis of the ion optical element decreases along the length of the inner channel.

The substrate 12 and the inner channel 14 extending therethrough can also exhibit a variety of shapes. While the example substrate 12 is generally cylindrical and the inner channel 14 also exhibits a circular cross-sectional area, the substrate and the inner channel defined thereby can exhibit non-circular, regular or irregular shapes and/or different cross-sectional shapes from one another. By way of non-limiting example, the perimeter of the substrate may be in the form of a polygon (e.g., triangle, square, rectangle), while the channel nonetheless exhibits a circular cross-sectional shape as shown in FIGS. 1A-B. Alternatively, the perimeter of the substrate may be circular as in FIGS. 1A-B, while the channel extending therethrough may be polygonal, for example. Additionally, in various aspects, each of the substrate and the channel defined therethrough may exhibit a polygonal cross-section. By way of example, the perimeter of the substrate and the channel may both be square, rectangular, triangular, etc.

The substrate 12 can comprise a variety of materials, although in some aspects the substrate 12 is an electrical insulator such that the ability of electrical current to flow therethrough is limited. By way of example, the insulating substrate may exhibit a conductivity less than about 0.001 S/m. In various aspects, the insulating substrate 12 may be effective to reduce the effect of external electric fields within the inner channel 14 and/or help ensure by its low conductivity that current preferentially flows through a resistive trace on the inner surface 14a of the substrate 12 when a voltage differential is applied across the first and second ends 12a,b of the substrate 12, as discussed in additional detail below. It will be appreciated by a skilled artisan in light of the present teachings that any electrical insulator known in the art and modified in accordance with the present teachings may be used to produce the substrate 12. By way of non-limiting example, the insulator may comprise any of ceramic, polymers, silicon, and glass. In certain aspects, the substrate material may be rigid and/or incompressible, especially when subjected to normal operating temperatures. Indeed, because of temperature changes to which the substrate 12 may be exposed during use within a mass spectrometry system, suitable materials may exhibit a low thermal expansion coefficient such that the substrate 12 does not change in size as a result of such temperature changes.

As shown in FIGS. 1A-B and noted above, the ion optical element 10 includes an electrical trace 16 that covers a portion of the inner surface 14a bounding the inner channel 14. In particular, in the example shown in FIGS. 1A-B, the electrical trace comprises a coil 16 having a plurality of windings or turns about the axis (A) as the trace extends continuously between the ends 12a,b of the substrate 12. It will be appreciated that though coil 16 is depicted as a cylindrical coil disposed on the cylindrical inner surface 14 of substrate 12 and having a consistent pitch, coils in accordance with the present teaching are not so limited as the coil can have a variety of cross-sectional shapes and of varying trace size and spacing (pitch). In any event, as will be appreciated by a person skilled in the art, a regular, circular coil having a number of turns (N) about a radius (R) at a coil pitch (P) along a coil height (H), the length (L) of the coil can be calculated as follows:

L=N\sqrt{(2πR)²+P²}

In accordance with various aspects of the present teachings, the coil 16 can comprise a resistive material that is configured to allow an electric current to be conducted along the length (L) of the trace, while maintaining a voltage differential thereacross. As shown in FIGS. 1A-B, for example, the pitch (P) of the trace is greater than the trace thickness such that each winding of the coil 16 is separated from its adjacent windings. In this manner, a voltage differential applied to the ends of the length of coil 16 will generate an electric current along the entire length (L) of the resistive trace (e.g., circumferentially about the axis (A)). By way of example, electrodes 18a,b (e.g., metallized contacts) are disposed adjacent the first and second ends 12a,b of the substrate 12 and in contact with the ends of the coil 16 such that a voltage differential can be applied across the length (L) of the trace. For example, one end of the coil 16 can have a non-zero DC voltage applied thereto, while the other end may be grounded. Alternatively, each end of trace 16 can be maintained at different, non-zero voltages. In this manner, the resistive trace can be thought of as a plurality of electrical resistors placed in series end to end, with the potential at each point along the windings of coil 16 varying as the voltage drops along the length (L) of the trace. In certain embodiments, as each winding of the coil 16 may comprise the same resistive material exhibiting a substantially constant bulk resistivity and having approximately the same cross-sectional area as shown in FIGS. 1A-B, the change in electric potential along the length (L) of the trace would be substantially linear. Moreover, where each winding of the resistive coil 16 is separated from adjacent windings by a substantially constant pitch as shown in FIGS. 1A-B, the change in electric potential along the length (L) of the trace would generate an electric field gradient within the channel 14 that is likewise substantially linear along the central axis (A).

A resistive trace 16 in accordance with the present teachings can comprise a variety of resistive materials, either known in the art or hereafter developed. Resistive materials suitable for use in accordance with various aspects of the present teachings include resistive films, for example, that may be deposited on the inner surface 14a of the substrate in the form of the electrical trace 16. Such coatings or films may include conductive particles or portions contained within a less conductive bulk material and can be deposited in a variety of patterns by processes such as chemical vapor deposition (CVD), atomic layer deposition (ALD), and printing a resistive ink in a coil pattern, all by way of non-limiting example. In various aspects, the material of the coil 16 and/or its resistivity may be selected in accordance with the characteristics of the one or more power supplies to which the resistive coil 16 is coupled. In various aspects, the resistivity of the coil 16 can maintain the voltage differential across ends 12a,b, as well as be sufficiently conductive relative to the insulating substrate 12 such that the current preferentially flows along the length (L) of the coil 16 (e.g., along the coil turns rather than through substrate 12 directly from end 12a to end 12b). For example, the resistivity of the coil 16 may be selected in view of the configuration of the coil 16 (e.g., thickness of the trace, number of turns, total length) such that a suitable current may be drawn from the one or more power supplies electrically coupled thereto. In some example aspects, the resistive coil 16 may exhibit a total resistance between the ends 12a,b of the insulating substrate 12 (e.g., along height (H)) in a range from about 1MΩ to about 1GΩ. Additionally or alternatively, the resistive coil 16 may exhibit a resistance between the ends 12a,b of the substrate 12 less than about 100 MΩ.

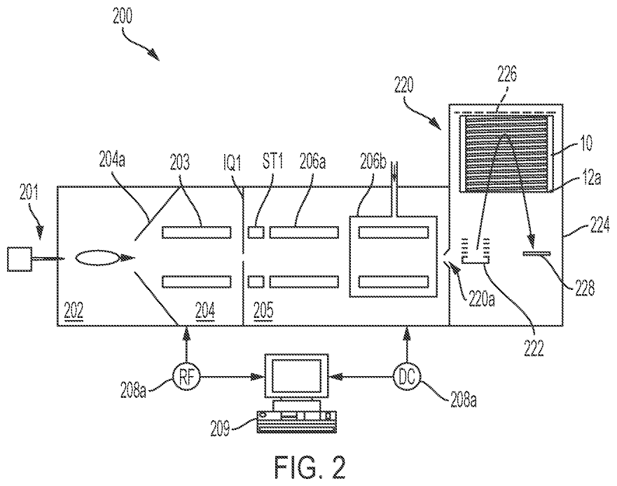

While ion optical elements described herein can be used in conjunction with many different mass spectrometry systems, FIG. 2 schematically depicts an exemplary MS-ToF system 200 incorporating the ion optical element 10 of FIG. 1 as an ion mirror within a time of flight mass analyzer 520 in accordance with various aspects of the present teachings. It should be understood that MS-ToF system 200 represents only one possible configuration and that ion optical elements in accordance with various aspects of the present teachings may be used to replace one or more conventional stacked-ring ion optical elements (e.g., ion guides, ion tunnels, ion funnels, reflectrons) in other MS systems.

As shown schematically in the exemplary embodiment depicted in FIG. 2, the MS-ToF system 200 generally includes an ion source 201 for generating ions within an ionization chamber 202, a collision focusing ion guide 203 (e.g., Q0) housed within a first vacuum chamber 204, a downstream vacuum chamber 205 containing one or more mass analyzers, and a time of flight mass analyzer 220. The exemplary system 200 additionally includes a controller 209 for controlling the operation of the various components of the system 200. For example, the controller 209 may be operatively coupled to one or more power supplies (e.g., RF power supply 208a and DC power supply 208b) so as to apply electric potentials with RF and/or DC components to the quadrupole rods, various lenses, and ion optical elements so as to configure the elements of the mass spectrometry system 200 for various modes of operation depending on the particular MS application.

Each of the various stages of the exemplary mass spectrometer system 200 will be discussed in additional detail with reference to FIG. 2. However, it will be appreciated that more or fewer mass analyzers or ion processing elements can be included in systems in accordance with the present teachings. For example, though the example second vacuum chamber 205 is depicted as housing two quadrupoles (i.e., elongated rod sets mass filter 206a (also referred to as Q1) and collision cell 206b (also referred to as q2), more or fewer mass analyzers may be provided. Further, though mass filter 206a and collision cell 206b are generally referred to herein as quadrupoles (that is, they have four rods) for convenience, the elongated rod sets 206a,b may be other suitable multipole configurations. For example, collision cell 206b can comprise a hexapole, octopole, etc. It will also be appreciated that the mass spectrometry system can comprise any of triple quadrupoles, linear ion traps, quadrupole time of flights, Orbitrap or other Fourier transform mass spectrometry systems, all by way of non-limiting examples.

Initially, the ion source 201 is generally configured to generate ions from a sample to be analyzed and can comprise any known or hereafter developed ion source modified in accordance with the present teachings. Non-limiting examples of ion sources suitable for use with the present teachings include atmospheric pressure chemical ionization (APCI) sources, electrospray ionization (ESI) sources, continuous ion sources, a pulsed ion source, an inductively coupled plasma (ICP) ion source, a matrix-assisted laser desorption/ionization (MALDI) ion source, a glow discharge ion source, an electron impact ion source, a chemical ionization source, or a photo-ionization ion source, among others.

Ions generated by the ion source 201 within ionization chamber 202 are drawn through an inlet orifice 204a to enter a collision focusing ion guide Q0 203 so as to generate a narrow and highly focused ion beam. In various embodiments, the ions can traverse one or more additional vacuum chambers and/or quadrupoles (e.g., a QJet® quadrupole or other RF ion guide) that utilize a combination of gas dynamics and radio frequency fields to enable the efficient transport of ions with larger diameter sampling orifices. The collision focusing ion guide Q0 generally includes a quadrupole rod set comprising four rods surrounding and parallel to the longitudinal axis along which the ions are transmitted. As is known in the art, the application of various RF and/or DC potentials to the components of the ion guide Q0 causes collisional cooling of the ions (e.g., in conjunction with the pressure of vacuum chamber 204), and the ion beam is then transmitted through the exit aperture in IQ1 (e.g., an orifice plate) into the downstream mass analyzers for further processing. The vacuum chamber 204, within which the ion guide Q0 is housed, can be associated with a pump (not shown, e.g., a turbomolecular pump) operable to evacuate the chamber to a pressure suitable to provide such collisional cooling. For example, the vacuum chamber 204 can be evacuated to a pressure approximately in the range of about 1 mTorr to about 30 mTorr, though other pressures can be used for this or for other purposes. For example, in some aspects, the vacuum chamber 204 can be maintained at a pressure such that pressure×length of the quadrupole rods is greater than 2.25×10⁻² Torr-cm. The lens IQ1 disposed between the vacuum chamber 204 of Q0 and the adjacent chamber 205 isolates the two chambers and includes an aperture through which the ion beam is transmitted from Q0 into the downstream chamber 205 for further processing.

Vacuum chamber 205 can be evacuated to a pressure than can be maintained lower than that of ion guide chamber 204, for example, in a range from about 1×10⁻⁶ Torr to about 1.5×10⁻³ Torr. For example, the vacuum chamber 205 can be maintained at a pressure in a range of about 8×10⁻⁵ Torr to about 1×10⁻⁴ Torr (e.g., 5×10⁻⁵ Torr to about 5×10⁻⁴ Torr) due to the pumping provided by a turbomolecular pump and/or through the use of an external gas supply for controlling gas inlets and outlets (not shown), though other pressures can be used for this or for other purposes. The ions enter the quadrupole mass filter 206a via stubby rods ST1. As will be appreciated by a person of skill in the art, the quadrupole mass filter 206a can be operated as a conventional transmission RF/DC quadrupole mass filter that can be operated to select an ion of interest or a range of ions of interest. By way of example, the quadrupole mass filter 206a can be provided with RF/DC voltages suitable for operation in a mass-resolving mode. As should be appreciated, taking the physical and electrical properties of the rods of mass filter 206a into account, parameters for an applied RF and DC voltage can be selected so that the mass filter 206a establishes a transmission window of chosen m/z ratios, such that these ions can traverse the mass filter 206a largely unperturbed. Ions having m/z ratios falling outside the window, however, do not attain stable trajectories within the quadrupole and can be prevented from traversing the mass filter 206a. It should be appreciated that this mode of operation is but one possible mode of operation for mass filter 206a. By way of example, in some aspects, the mass filter 206a can be operated in a RF-only transmission mode in which a resolving DC voltage is not utilized such that substantially all ions of the ion beam pass through the mass filter 206a largely unperturbed (e.g., ions that are stable at and below Mathieu parameter q=0.908). Alternatively, a lens (not shown) between mass filter 206a and collision cell 206b can be maintained at a much higher offset potential than the rods of mass filter 206a such that the quadrupole mass filter 206a be operated as an ion trap. Moreover, as is known in the art, the potential applied to the entry lens of collision cell 206b can be selectively lowered (e.g., mass selectively scanned) such that ions trapped in mass filter 206a can be accelerated into the collision cell 206b, which could also be operated as an ion trap, for example.

Ions transmitted by the mass filter 206a can pass through post-filter stubby rods and entry lens (not shown) into the quadrupole 206b, which as shown can be disposed in a pressurized compartment and can be configured to operate as a collision cell at a pressure approximately in the range of from about 1 mTorr to about 30 mTorr, though other pressures can be used for this or for other purposes. A suitable collision gas (e.g., nitrogen, argon, helium, etc.) can be provided by way of a gas inlet (not shown) to thermalize and/or fragment ions in the ion beam. In some embodiments, application of suitable RF/DC voltages to the quadrupole 206b and entrance and exit lenses (not shown) can provide optional mass filtering and/or trapping. Similarly, the quadrupole 206b can also be operated in a RF-only transmission mode such that substantially all ions of the ion beam pass through the collision cell 206b largely unperturbed.

Ions transmitted by collision cell 206b (e.g., product and/or precursor ions) through ion inlet 220 pass into the ToF analyzer 220 disposed in a high-vacuum chamber, which may be maintained at a decreased operating pressure, for example, at a pressure in a range from about 1×10⁻⁶ Torr to about 1.5×10⁻³ Torr (e.g., about 5×10⁻⁵ Torr), though other pressures can be used for this or for other purposes. Ions entering the ToF analyzer 220 may be accelerated across a field-free drift chamber 224 toward the ion optical element 10 via the application of a short, high voltage pulse applied to pusher plate 222 adjacent the ion inlet 220a. By applying a selected voltage differential across the coil 16 of the ion optical element 10, an electric field is generated within the channel 14 having a gradient along the axis due to the voltage drop across the coil 16 that is configured to decelerate ions entering the first end 12a of the optical element 10 until they reach zero kinetic energy, turn around, and are reaccelerated back through the ion optical element 10, exiting the first end 12a with energies and speed identical to their incoming energy and speed. A detector 228 is configured to detect the reflected ions. As shown, a solid reflector plate or grid 226 may be disposed across the channel 14 adjacent the second end 12b of the substrate 12 to provide a constant electrical potential across the end of the channel 12b. Because ions of the same m/z with larger energies penetrate the ion mirror 10 more deeply and will have longer flight paths, the ions arrive at the ion detector 28 at very nearly the same time as less energetic ions of that m/z, thereby minimizing the arrival spread of the ions due to initial kinetic energy differences and increasing the resolution of the ToF analyzer 220.

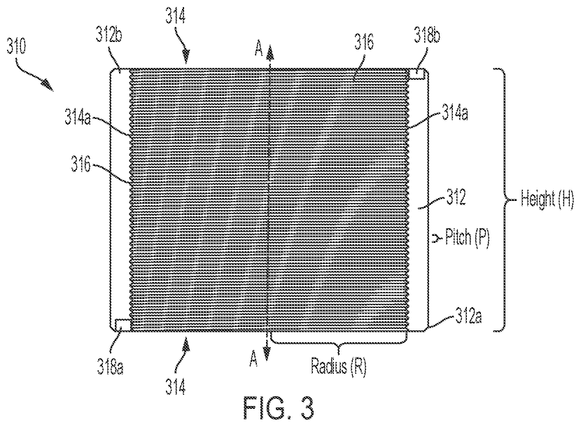

It will be appreciated that in the depiction of FIGS. 1A-B and 2, the ion optical element 10 functions as a single-stage reflectron having a single electric field region. In a case in which the depicted resistive coil 16 exhibits substantially consistent resistance along its length and a substantially consistent pitch, maintaining the ends of the coil 16 adjacent the ends 12a,b of the substrate 12 at different potentials can result in a substantially linear change in the electric potential along the axis of the inner channel 14. With reference now to FIG. 3, another example ion optical element 310 for generating a linear electric field gradient in accordance with various aspects of the present teachings is depicted. Ion optical element 310 is similar to ion optical element 10 of FIGS. 1A-B, but differs in that the thickness of each trace along the axis (A) and spacing between adjacent windings of the coil 316 is reduced relative to that of coil 16. As such, for the same height (H) of coils 16, 316, coil 316 has a significantly higher number of turns than coil 16. While the separation between adjacent windings helps ensure that the current goes through the entire length of the trace around perimeter of the channel 314 to provide a consistent voltage drop therearound, the decreased pitch as schematically depicted in FIG. 3 may help provide an electric field exhibiting increased uniformity. For example, the electric field generated by more tightly-spaced windings may exhibit fewer perturbations near the perimeter of the channel 314 due to the decreased spacing. Indeed, in various aspects, coil traces in accordance with various aspects of the present teachings can exhibit a reduced thickness (e.g., along the axial direction) relative to the thickness of each ring in a conventional stacked-ring ion guide and/or exhibit reduced spacing relative to the spacers separating such rings. By way of non-limiting example, whereas the rings of some commercially-available stacked-ring ion guides typically have a thickness of at least 2.0 mm and are separated from adjacent rings by at least 4.0 mm, coil traces in accordance with some aspects of the present teachings can have a thickness of 0.5 mm and/or less and a pitch of 0.5 mm or less, though ion optical elements according to these or other dimensions can be suitable for use as an ion mirror or other purposes. As noted above, such a tight coil in ion optical elements according to the present teachings can thereby improve the uniformity of the electric field relative to conventional stacked-ring optical elements by reducing discontinuities near the outer edge of the channel which can cause ion scattering and decreased resolution.

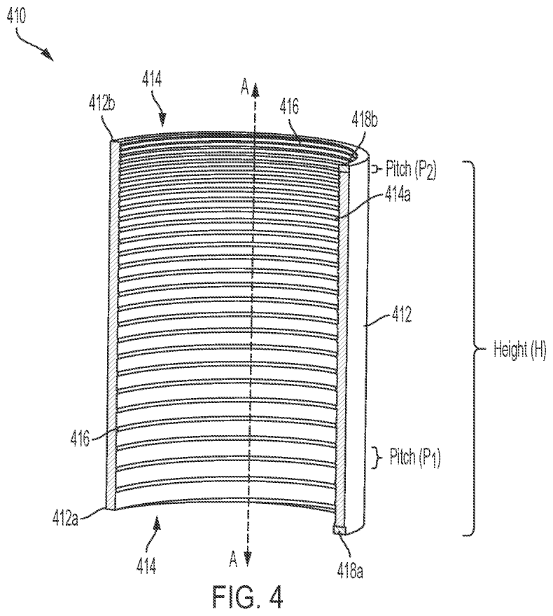

In addition to substantially linear electric field gradients as discussed above with respect to ion optical elements 10, 310 of FIGS. 1 and 3, ion optical elements in accordance with various aspects of the present teachings can also be configured to provide a non-linear electric field gradient. By way of non-limiting example, a non-linear electric field gradient can be generated along the axis of the ion optical element by varying one or more of the resistivity of the material utilized to form the resistive trace and/or the coil shape, size, or pitch. With reference now to FIG. 4, an example ion optical element 410 for generating a non-linear electric field gradient in accordance with various aspects of the present teachings is depicted. As with ion optical elements 10, 310 of FIGS. 1 and 3, ion optical element 410 comprises an insulator substrate 412 having a channel 414 extending therethrough along an axis (A). A resistive coil 416 is coupled to (e.g., formed on) the inner surface 414a of the substrate 412. However, unlike coils 16, 316, windings of coil 416 exhibit a pitch that varies along the height (H) of the coil 426. In particular, the spacing between adjacent windings decreases from the first end 426a to the second end 426b (e.g., P₁>P₂). In the case of a consistent resistance along the length of the trace, it will be appreciated that the potential drop per unit height along the axis (A) changes as the coil pitch changes. The depiction in FIG. 4 is but one example configuration of an ion optical element for producing a non-linear electric field gradient along the axis (A). By way of example, changes to the resistance of a trace forming a coil having a consistent pitch, either through changes to the resistivity of the trace material or to the size/shape of the trace (e.g., changes to the cross-sectional area of the trace) along different portions of the coil can similarly result in non-linear electric field gradients.

In addition to providing a non-linear electric field gradient within a single, unitary ion optical element as described above with reference to FIG. 4, a desired electric field can also be generated in accordance with various aspects of the present teachings by aligning the inner channels of a plurality of ion optical elements described herein, each of which may define a distinct electric field. By way of example, two ion optical elements in accordance with the present teachings can be aligned to function as a dual-stage ion mirror in that each ion optical element can define distinct regions (stages) exhibiting different fields as in a conventional dual-stage stacked-ring reflectron, which typically are able to focus ions over a larger kinetic energy ring relative to a single-stage ion mirror. For example, a first ion optical element (e.g., closest to the pusher plate 222) can exhibit a high electric field in which the entering ions are initially decelerated (i.e., lose kinetic energy), while the second ion element can represent the second stage having a lower field for repelling the ions back toward the first stage. Ion mirrors with additional stages are also within the scope of the present teachings.

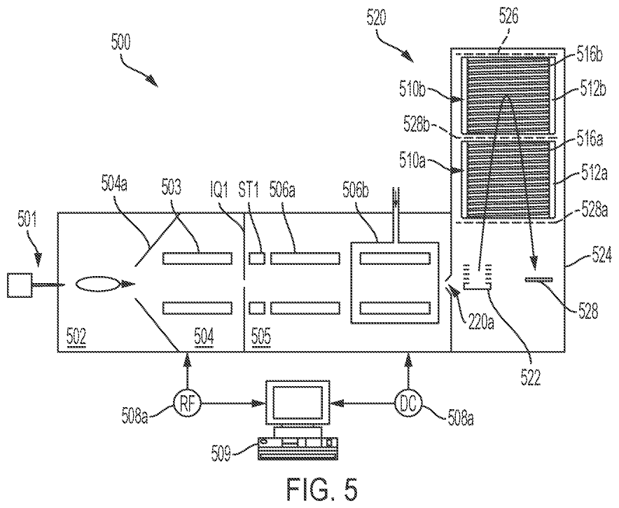

With reference now to FIG. 5, another exemplary MS-ToF system 500 incorporating an ion optical element in accordance with the present teachings is schematically depicted. MS-ToF system 500 is similar to the system of FIG. 2 but differs in that the ToF analyzer 520 includes a dual-stage ion mirror in which the inner channels of two insulating substrates 512a,b are aligned such that ions can be subjected to the electric fields generated in the respective stages 510a,b by coils 516a,b.

Single-stage and multi-stage ion mirrors in accordance with the present teachings can have grids or be gridless. Conventionally, grids are optionally utilized in reflectrons to provide a constant electrical potential across a channel, for example, to terminate a field and/or separate fields applied to different regions of the ion mirror. As shown in FIG. 5, the ToF analyzer 520 includes a reflector plate or grid 526 adjacent the distal end of the second stage 510b that provides a constant electrical potential across the end of the channel. In addition, the ToF analyzer includes an entrance grid 528a that separates the field free region 522 from the electric field generated within the first stage 510a and a middle grid 528b that separates the electric field within the first stage 510a from that of the second stage 510b. In various aspects, the grids 528a,b can be formed of conductive materials and can be maintained at the same potential as the ends of the associated coils 516a,b. By way of example, the potential applied to the middle grid 526b can be the same as the potential applied to the second, distal end of the first coil 516a and the first, proximal end of the second coil 516b.

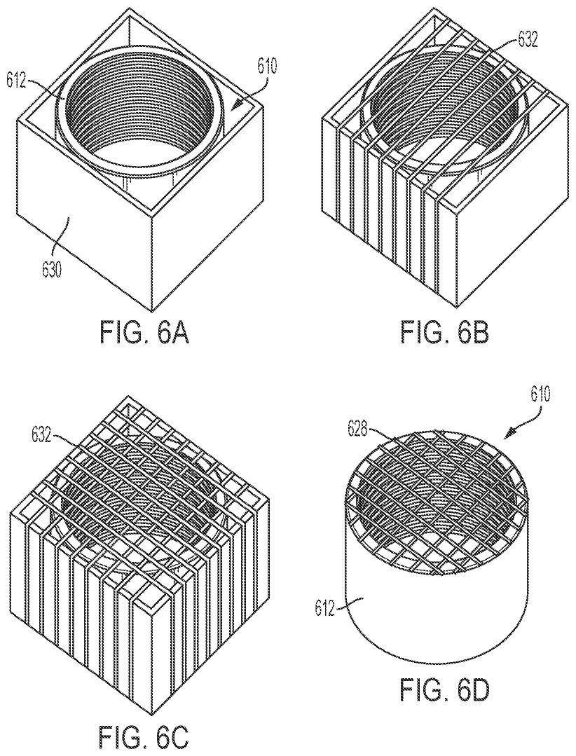

As noted above, known methods of incorporating grids into conventional stacked-ring ion mirrors can also add to the complexity and cost of manufacturing. For example, grids are typically manufactured independently from the other components, and care must be taken to ensure that the grids remain flat when inserted between rings, for example, so as not to distort the electric fields within the ion mirror. FIGS. 6A-D schematically depict an example method for coupling a grid to an ion optical element in accordance with various aspects of the present teachings. As shown in FIG. 6A, the ion optical element 610 may be placed inside a jig 630 having the same height as the substrate 612. FIGS. 6B and 6C schematically depict wrapping conductive wires 632 about the jig 630 such that the wires are disposed across the ends of the substrate 612 in a grid pattern. By way of non-limiting example, the wires 632 may be wrapped in a first direction as in FIG. 6B and then a second, orthogonal direction as in FIG. 6C. After wrapping the wires 632 about the jig 630, the wires 632 may be bonded to one or more ends of the substrate 612, depending if a grid is to be disposed across one or both ends of the inner channel of the substrate 612. The wires 632 may be bonded in a variety of manners such as adhesive, welding, etc. After bonding, the wires 632 may be cut around the perimeter of the substrate 612 so as to remove the portion of the wires 632 extending along the perimeter of the insulating substrate 612, thereby leaving a grid 628 upon removal of the jig 630 as shown in FIG. 6D. A jig need not be required though it may further ease manufacture, especially when the substrate 612 is cylindrical in form. For example, in the case of a substrate having a square cross-sectional area, the wires may be wrapped directly on the perimeter of the substrate.

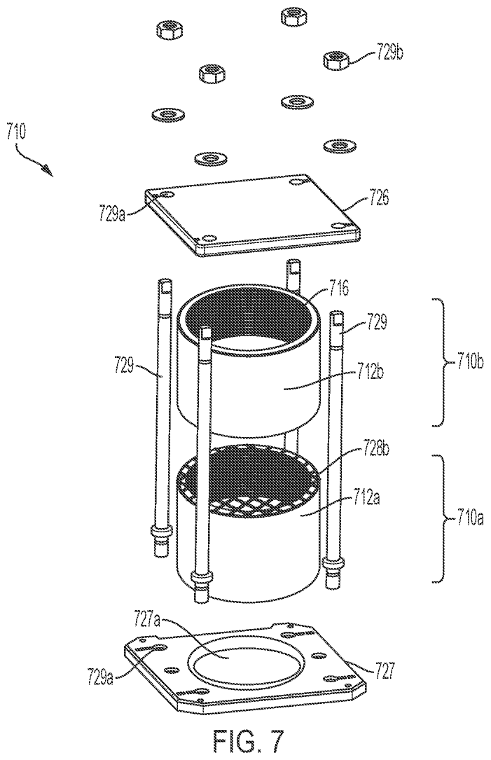

With reference now to FIG. 7, assembly of a dual-stage gridded ion mirror assembly 710 in accordance with various aspects of the present teachings is depicted. As shown, two insulating substrates 712a,b are provided, each of which comprises a respective resistive coil 716 as otherwise discussed herein. The first substrate 712a, which forms part of the first stage 710a of ion mirror 710, has two grids, of which only one grid 728b is in view from the perspective of FIG. 7. In particular, as discussed above with reference to element 528b of FIG. 5, the depicted middle grid 728b is effective to separate the electric fields generated within each of the stages 710a,b. The other grid (not shown) represents the entrance grid (e.g., grid 528a of FIG. 5).

As shown, the ion mirror comprises a reflector plate 726 as well as an entrance plate 727 defining an opening 727a therethrough through which ions may be received at the first end of the first stage 710a. Each of the reflector plate 726 and entrance plate 727 comprise a plurality of bores 729a through which ends of the posts 729 may be inserted. In some aspects, at least one end of the posts 729 may be threaded so as to allow a nut and washer 729b to secure the assembly 710 together. In some aspects, the posts 729 may comprise rigid material exhibiting a low thermal expansion coefficient such that the ion mirror assembly 710 does not change in size and/or shape as a result of temperature changes during operation thereof. It will be appreciated that though the assembly 710 is described above as an ion mirror, the present teachings may also be utilized to generate ion optical elements for use as other devices in MS systems, such as ion guides, ion tunnels, ion funnels, all by way of non-limiting example. In an assembly similar to that of FIG. 7 and suitable for use as an ion tunnel, for example, both plates disposed at opposite ends of the assembly may comprise central openings such that ions may be transmitted into one end of the assembly and out of the other (e.g., to a downstream mass analyzer).

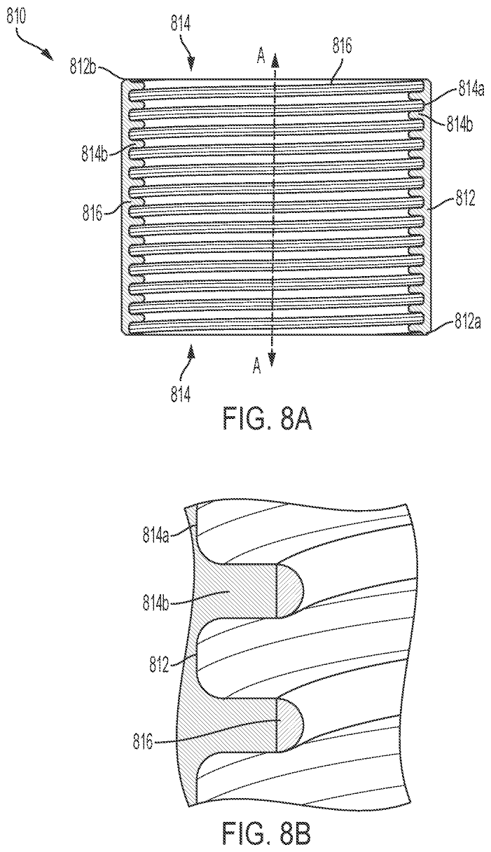

As noted above, the inner channel of the substrate can have a variety of cross-sectional shapes including regular and irregular shapes. Though the example substrates described in detail above in FIGS. 1 and 3, for example, exhibit a substantially smooth inner sidewall having a generally constant cross-sectional shape and area along the height of the axis (A), ion optical elements can, in some aspects, exhibit one or more inwardly-extending projection. For example, FIGS. 8A-B depicts another exemplary ion optical element 810 in accordance with various aspects of the present teachings in which the inner surface 814a of the substrate 812 comprises a projection 814b extending radially toward the central axis of the channel. In particular, the inner surface 814a comprises a spiral projection 814b extending continuously from the first end 812a to the second end 812b of the substrate 812. As shown, a resistive coil 816 may be formed on the axially-facing surface of the projection 814b such that the resistive material through which the current flows is on the innermost surface of the projection 814b. Such one or more projections 814b may be formed in a variety of manners. By way of example, the substrate 812 may be cast (e.g., molded) from an insulative material into a desired shape such that the inner surface 814a exhibits a contoured profile. Alternatively, it will be appreciated that such one or more projections 814b may be formed by removing surface material from the sidewall of a substrate pre-form initially having a smooth inner surface. By way of example, material may be selectively ground from portions of an insulator pre-form having a circular cross-section to generate a spiral shape as depicted in FIGS. 8A-B. In certain aspects, by forming the coil 816 on the radially-facing surface of projection 814b such that each coil winding is separated from adjacent coil windings by a concave portion of uncoated substrate 812, such a configuration may beneficially mitigate potential charging of the exposed portions of substrate 812. For example, without being bound by any particular theory, by placing the resistive coil 816 relatively closer to the path of ions transmitted through channel 814, it is believed that any charges accumulated on uncoated portions of substrate 812 could have reduced impact on the electric field.

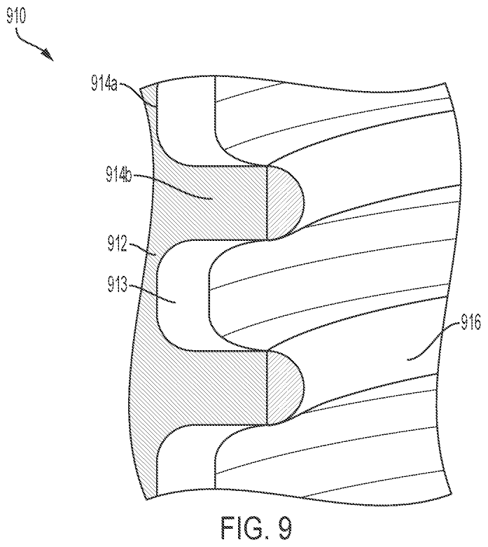

Though adjacent windings of coil 816 are depicted in FIGS. 8A-B as being separated by uncoated portions of the substrate 812, in certain aspects, adjacent windings of a resistive coil may additionally or alternatively be separated from one another by a material different from that of the insulating substrate and resistive coil. As shown in FIG. 9, for example, after forming the projections 914b on an inner surface 914a of substrate 912, the concave portions of the inner surface 914a may be at least partially filled with a highly-resistive material 913. For example, such highly-resistive material may exhibit resistivity several orders of magnitude greater than that of the resistive coil 916. In this manner, current will flow through the resistive coil 916 when a voltage differential is applied to the ends of resistive coil 916 under normal operating conditions, with the highly-resistive material 913 being effect to dissipate (e.g., bleed off any excessive charge buildup within the grooves between projections 914b).

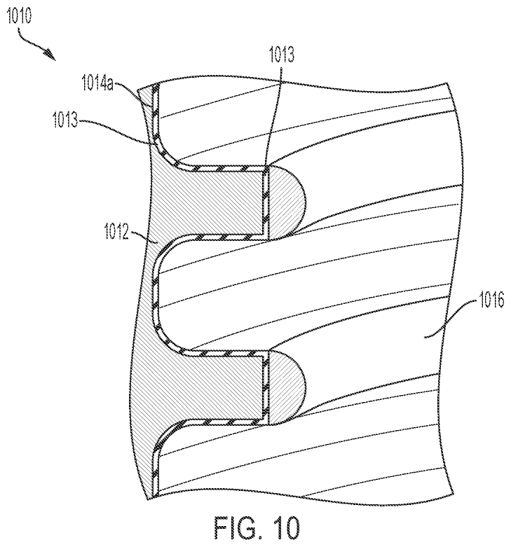

Alternatively, as shown in FIG. 10, for example, a layer of distinct highly-resistive material 1013 may be deposited across the entire inner surface 1014a of the substrate 1012. By way of non-limiting examples, such a layer of highly-resistant material 1013 may be formed by coating the inner surface 1014a with high-resistivity paint, printing a coating, depositing via CVD, or depositing via ALD. Thereafter, the resistive trace can be formed on at least the innermost surface of the coated projections 1014b such that each winding of the coil 1016 is separated from adjacent windings by the material 1013, which may exhibit a substantially high resistivity relative to the material of the resistive coil 1016. As described above with reference to FIG. 9, current will tend to flow through the relatively lower resistivity resistive coil 1016 under normal operating conditions, with the highly-resistive material 1013 being effective to dissipate any excessive charge buildup of the substrate 1012.

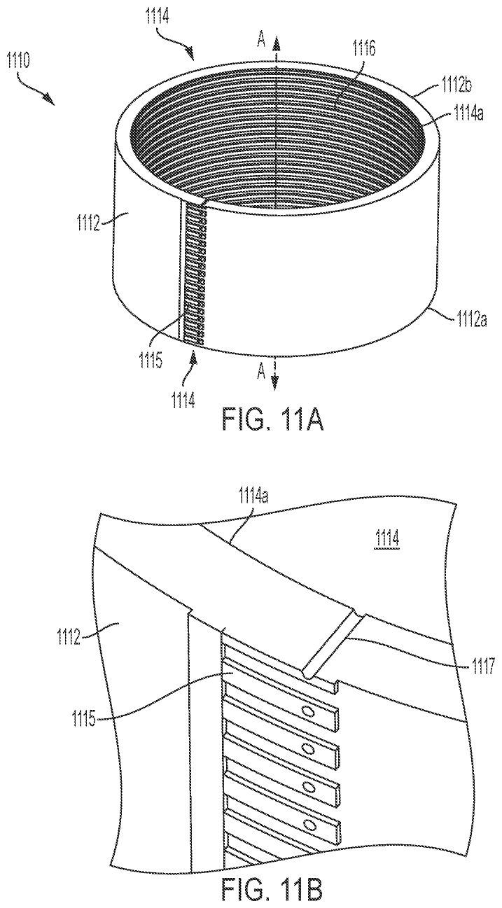

With reference now to FIGS. 11A-B, another example ion optical element 1110 for controlling the path of charged particles (e.g., ions) according to various aspects of the present teachings is depicted in perspective and cross-sectional views. As shown, the ion optical element comprises a body or substrate 1112 extending from a first end 1112a to a second end 1112b and defining an inner channel 1114 extending along axis (A). The channel 1114 opens at each of the first and second ends 1112a,b of the substrate 1112 to allow ions to enter and/or exit the inner channel 1114.

The ion optical element 1110 also includes an electrical trace that covers a portion of the inner surface 1114a. However, whereas the resistive coils 16, 316 discussed above with reference to FIGS. 1 and 3 extend continuously from end to end such that current flows circumferentially about the axis in a spiral shape from one end of the respective substrates to the other, the electrical trace of FIGS. 11A-B instead comprises a plurality of conductive rings 1116 that encircle the inner channel 1114 and may be maintained at a specific potential at each height of the particular ring 1116. That is, the voltage of each ring 1116 at any circumferential position is substantially equivalent. In certain aspects, such rings 1116 may be equally-spaced from one another, although irregular spacing is also contemplated herein.

A voltage signal applied to the rings 1116 adjacent the ends 1112a,b of the substrate 1112, for example, via electrodes (not shown) may be propagated from ring 1116 through one or more resistive elements 1115 disposed therebetween. As best seen in FIG. 11B, for example, each ring 1116 may be electrically coupled to adjacent ring(s) by way of a via 1117 extending through a channel 1115 extending through the insulating substrate's sidewall 1114a. The vias associated with adjacent rings 1116 may be coupled by resistive elements 1115, which are external to the inner channel 1114 and whose resistance can be selected so as to provide a desired voltage drop between adjacent rings. As each ring may be maintained at a desired potential, an electric field gradient generated within the inner channel 1114 can be used to control the motion of ions therein, as otherwise discussed above.

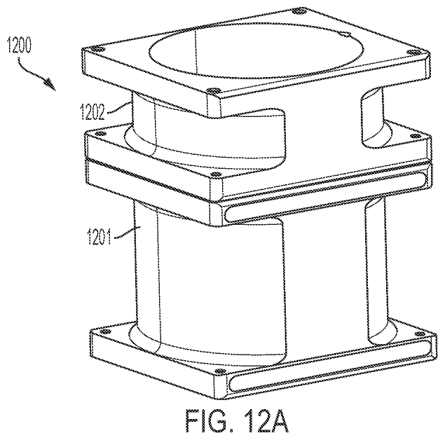

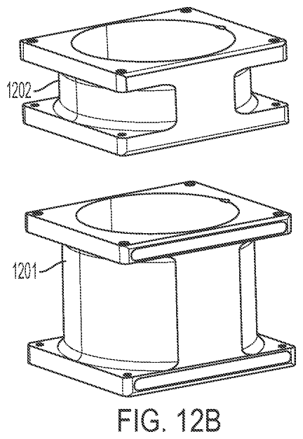

FIGS. 12A and 12B schematically depict an ion optic assembly 1200 according to an embodiment, which can be used, for example, as an ion mirror in a mass spectrometric system. The ion optic assembly 1200 includes two ion optics 1201 and 1202 that are coupled to one another, each of which provides an ion passageway (herein also referred to as a passageway, or an ion channel) through which ions can pass and each of which is configured to provide an electric field along the longitudinal axis of its respective ion passageway for influencing the motion of the ions passing through the passageway. More specifically, as discussed in more detail below, each of the ion optics 1201/1202 includes a spiral electrically resistive trace disposed on an inner surface thereof to which voltages can be applied to induce flow of a current through the resistive trace, which in turn generates an electric field along the longitudinal axis of the respective passageway.

As discussed in more detail below, the ion optics 1201/1202 are electrically coupled to one another via a grid, which is maintained at a reference electric potential (e.g., at ground electric potential) such that electric fields with different field strengths can be generated in the ion passageways of the two ion optics, 1201/1202.

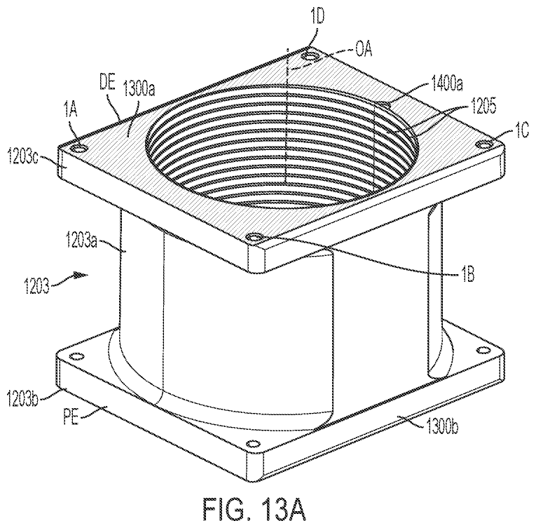

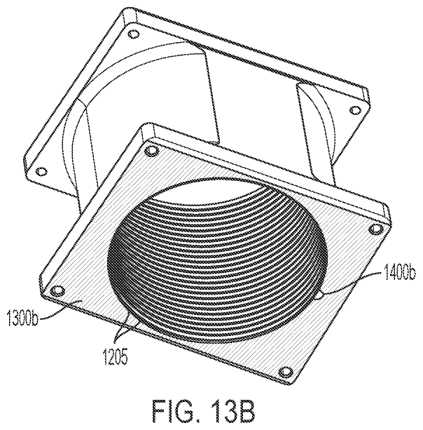

In particular, with reference to FIG. 13A, the ion optic 1201 includes a body 1203 that extends from a proximal (PE) end to a distal end (DE) along a longitudinal axis (OA). The body 1203 includes a substantially cylindrical portion 1203a that is flanked by two flanges 1203b/1203c. The cylindrical portion 1203a is hollow and provides a lumen (herein also referred to as a passageway or an ion passageway) through which ions can propagate. The body 1203 can be formed of a variety of non-conductive materials. In this embodiment, the body 1203 is formed of a ceramic though any other suitable electrically insulating material may be employed.

A spiral resistive trace 1205 is deposited on an inner surface of the cylindrical portion 1203a. The resistive trace 1205 extends from a proximal end of the ion optic to its distal end. In this embodiment, the widths and axial separations of the loops of the spiral trace 1205 are substantially uniform to ensure that a substantially uniform electric field can be generated within the ion passageway associated with the ion optic 1201. By way of example, and without limitation, the widths of the spiral loops of the resistive trace 1205 can be in a range of about 0.1 mm to about 5 mm, and the axial separation of adjacent loops can be in a range of about 0.1 mm to about 5 mm, or varied along the axial length of the cylinder all by way of example. In some embodiments, the electrical resistance of the resistive trace 1205 can be in a range of about 1 MΩ (Mega Ohm) to about 10 GΩ (Giga Ohm), e.g., in a range of about 1 MΩ to about 1 GΩ, e.g., in a range of about 10 MΩ to about 100 MΩ.

As shown schematically in FIGS. 13A and 13B, the top and bottom surfaces of the ion optic 1201 are metalized. More specifically, in this embodiment, the top surface of the ion optic 1201 is coated with a thin metal layer 1300a and the bottom surface of the ion optic 1201 is coated with a thin metal layer 1300b. In some embodiments, the thickness of the metal layers 1300a and 1300b can be, for example, in a range of about 1 μm to about 100 μm.

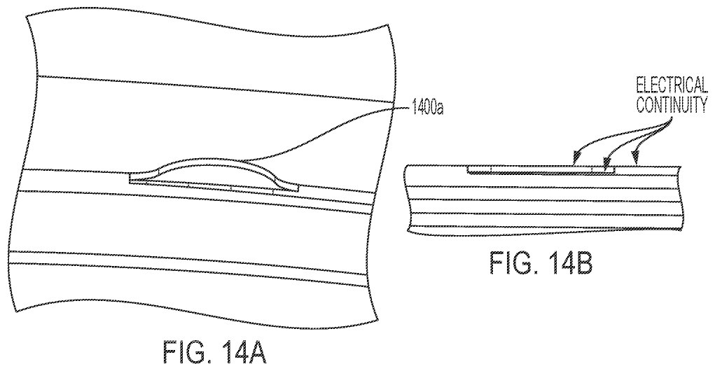

The resistive trace 1205 is electrically coupled at its proximal and the distal ends to the metalized layers 1300a and 1300b. More specifically, with a reference to FIGS. 13A, 14A and 14B, an electrically conductive tab 1400a positioned at the distal end of the ion optic 1201 provides an electrical connection between the distal end of the resistive trace 1205 and the top metal layer 1300a. In this embodiment, the conductive tab is formed by generating a small cavity in the body of the ion optic and filling the cavity with a conductor. A similar conductive tab 1400b positioned at the proximal end of the ion optic 1201 provides electrical connection between the proximal end of the resistive trace 1205 and the metal layer 1300b. The portions of the resistive trace in vicinity of the top and the bottom metal layers are configured to ensure that the only electrical contact between the resistive trace and each of the metal layers 1300a/1300b is achieved via a respective conductive tab.

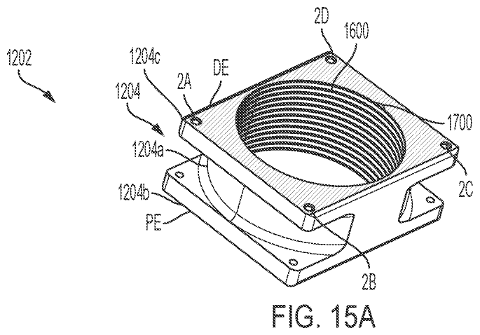

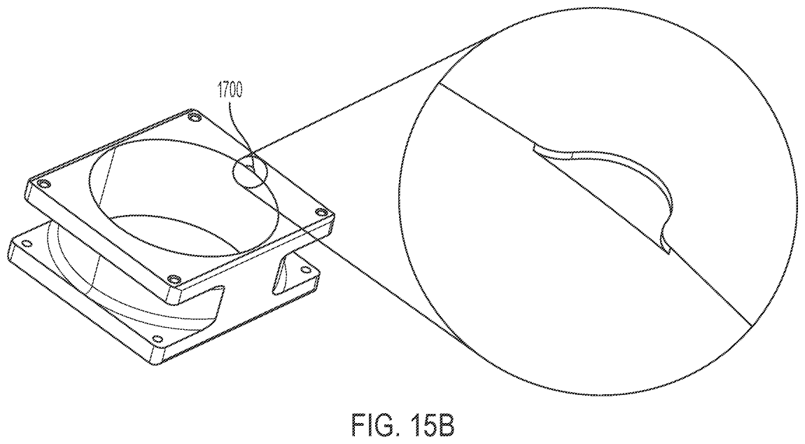

With reference to FIG. 15A, the ion optic 1202 extends from a proximal end (PE), which is coupled to the distal end of the ion optic 1201, to a distal end (DE). The ion optic 1202 includes a body 1204 having a hollow cylindrical portion 1204a that is flanked by two flanges 1204b and 1204c. The flange 1204b includes four openings 2A, 2B, 2C, and 2D that can be placed in register with the openings (1A, 1B, 1C, and 1D) of the flange 1300a to allow mechanical coupling of the two flanges via suitable fasteners, e.g., screws.

Similar to the ion optic 1201, the ion optic 1202 includes a spiral resistive trace 1600 that is deposited on an inner surface of the cylindrical portion 1204a so as to provide a continuous resistive path that extends from a proximal end positioned in proximity of the proximal end of the ion optic 1202 to a distal end positioned in proximity of the distal end of the ion optic 1202. In this embodiment, the width of the resistive trace as well as the relative axial spacings between the loops of the resistive trace are substantially uniform to facilitate the generation of a substantially uniform longitudinal electric field within the ion passageway provided by the cylindrical portion 1204a. In other embodiments, the widths and/or the spacings of the loops of the spiral resistive trace can be non-uniform to allow the generation of an electric field, e.g., along the longitudinal axis of the ion passageway provided by the cylindrical portion 1204a. In some embodiments, the electrical resistance of the resistive trace 1600 can be in a range of about 1 MΩ (Mega Ohm) to about 10 GΩ (Giga Ohm), e.g., in a range of about 1 MΩ to about 1 GΩ, e.g., in a range of about 10 MΩ to about 100 MΩ.

With reference to FIG. 15A as well as 15B (the resistive trace is not depicted in FIG. 15B), similar to the previous embodiment, the distal end of the electrically resistive trace 1600 terminates in an electrically conductive tab 1700 and the proximal end of the electrically conductive trace 1600 terminates in a similar electrically conductive tab (not visible in the figures).

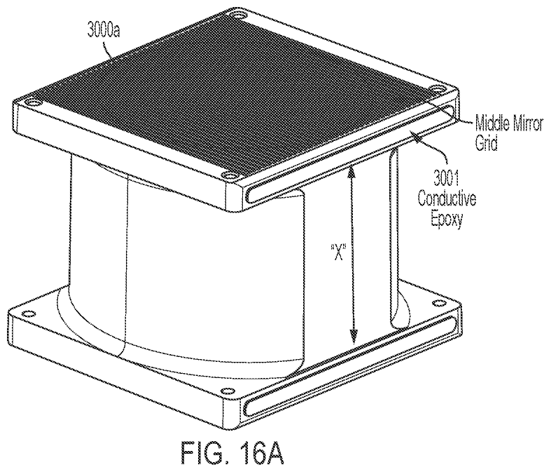

As shown schematically in FIGS. 16A and 16B, metal grids 3000a and 3000b are disposed on the proximal end and the distal end of the ion optic 1201. By way of example, the metal grids 3000a and 3000b can be formed by winding a plurality of grid wires around the body of the ion optic covering the distal and the proximal surfaces of the ion optic and its sides. After wrapping the grid wires around the body of the ion optic 1201, the grid wires can be fixed in place with a conductive epoxy 3001. After the epoxy dries, the portions of the grid wires on the sides of the ion optic (e.g., the area labeled “X”) are removed, e.g., cut, to provide two separate metal grids, namely, the metal grids 3000a and 3000b.

Upon assembly of the two ion optics 1201/1202, the metal grid 3000a is positioned between the ion passageways of the two ion optics. The metal grid 3000a (which is herein also referred to as the middle grid) can be maintained at a reference electric potential (e.g., the electric ground) to provide electrical connection between the two resistive traces 1205 and 1600, thereby allowing a well-defined termination of the established independent electric fields in the ion passageways associated with the two ion optics.

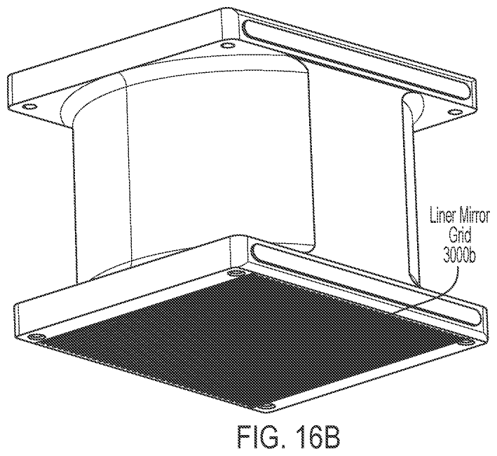

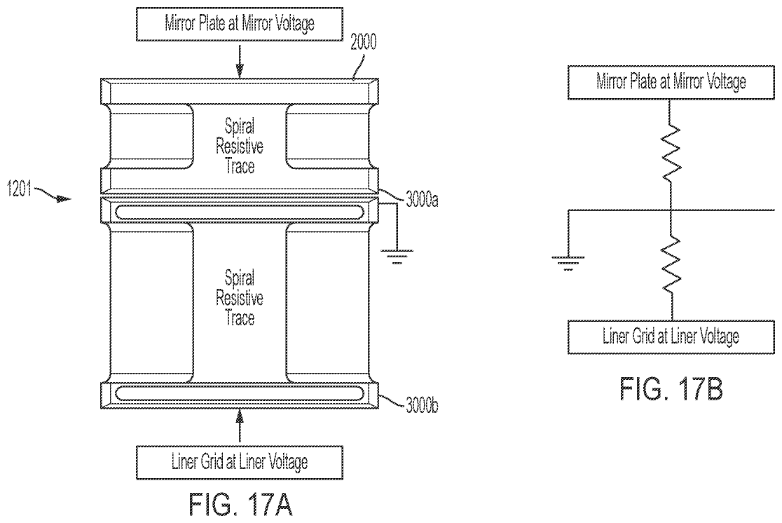

As depicted schematically in FIGS. 17A and 17B, in use, the middle grid 3000a can be maintained at a reference electric potential, e.g., the electric ground in this example. The grid 3000b positioned at the proximal end of the ion optic 1201 can be maintained at an electric potential that can facilitate the establishment of a well-defined electric field and allows for entry of ions into the ion optic 1202. The ions entering the ion optic 1201 will be subjected to the electric field within the ion optic 1201 as they pass through the ion passageway associated with the ion optic 1201. The ions pass through the middle grid 3000a to enter the ion optic 1202 where the ions will be subjected to the electric field within the ion passageway of the ion optic 1202. A mirror plate 2000 positioned at the distal end of the ion optic 1202 can be maintained at a voltage such that the ions are repelled by the electric field between the mirror plate 2000 and the middle grid and reverse their propagation direction to traverse the ion passageways of the ion optics 1202/1201 in the opposite direction and exit the ion optic 1201 through the grid 3000b.

As noted above, the use of two ion optics 1201/1202 allows establishing independent electric fields within the ion passageways of the two ion optics. This in turn allows adjusting the electric fields in the two ion optics, including the strengths of the respective electric fields, so as to provide focusing of the ions as they pass through the ion optics 1201 and 1202.

As noted above, in some embodiments, the widths and/or the axial spacings of the loops of the resistive traces 1205 and 1600 can be non-uniform so as to allow the generation of an electric field within the ion passageways of one or both ion optics. By way of example, the spacing between the adjacent loops of either resistive trace 1205 and/or 1600 can progressively decrease from the proximal end of the ion optic to its distal end, e.g., in a manner schematically depicted in FIG. 4.

In general, the axial lengths of the ion optics 1201 and 1202 can be selected based on a particular application. While in this embodiment, the ion optic 1201 has a larger axial extent that the ion optic 1202, in other embodiments, other combination of the relative axial extents of the ion optics may be employed.

By way of example, in some embodiments, the resistive traces discussed above can be formed on an inner surface of the optics via deposition of a slurry containing a resistive ink as a spiral pattern on the inner surfaces of the optics' lumen and treating the deposited ink, e.g., via heating the deposited slurry to an elevated temperature (e.g., an elevated temperature of about 800 C).

Further, as discussed above, in many embodiments, the resistive traces are configured to ensure the establishment of a substantially uniform electric field within the optics. By way of example, in some embodiments, the axial variation of such a substantially uniform electric field along the axial extent of the optic can be less than about 5%, or preferably, less than about 1%.

The descriptions herein of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software, though the present teachings may be implemented as a combination of hardware and software or in hardware alone. The present teachings may be implemented with both object-oriented and non-object-oriented programming systems.

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

1. An ion optical element, comprising:
an insulating substrate having an inner channel bounded by an inner surface of the insulating substrate and extending along an axis from a first end to a second end thereof; and
a resistive coil coupled to the inner surface and continuously extending from the first end to the second end of the insulating substrate, wherein maintaining a voltage differential across the resistive coil is configured to generate an electric field within the inner channel for controlling axial motion of ions therein.

2. The ion optical element of claim 1, wherein the resistive coil comprises a plurality of revolutions about the inner channel, wherein each revolution is separated from an adjacent revolution by uncoated portions of the insulating substrate.

3. The ion optical element of claim 1, wherein the resistive coil comprises a plurality of revolutions about the inner channel, wherein each revolution is separated from an adjacent revolution by a relatively higher resistivity coating.

4. The ion optical element of claim 1, wherein the resistive coil comprises a resistive coating formed on the inner surface of the insulating substrate.

5. The ion optical element of claim 4, wherein the inner surface comprises at least one inwardly-extending projection extending from the first end to the second end of the insulating substrate, wherein the resistive coating is formed on at least an innermost surface of the at least one projection.

6. The ion optical element of claim 1, wherein the ion optical element comprises a time-of-flight ion mirror.

7. The ion optical element of claim 1, wherein, when a first end of the resistive coil adjacent the first end of the insulating substrate is maintained at a first DC potential and a second end of the resistive coil adjacent the second end of the insulating substrate is maintained at a second DC potential, a gradient of the electric field is substantially linear along the axis of the inner channel.

8. The ion optical element of claim 1, further comprising at least one DC voltage source coupled to the resistive coil.

9. The ion optical element of claim 1, wherein the insulating substrate comprises one of ceramic, polymers, silicon, and glass, and optionally, wherein the insulating substrate comprises ceramic, and wherein optionally the insulating substrate exhibits an electrical conductivity of less than about 0.001 S/m.

10. The ion optical element of claim 1, wherein the resistive coil exhibits a resistance between the first and second ends of the insulating substrate in a range from about 1MΩ to about 1GΩ, and wherein optionally the resistive coil exhibits a resistance between the first and second ends of the insulating substrate less than about 100 MΩ.

11. The ion optical element of claim 1, wherein the insulating substrate is a first insulating substrate, the device further comprising:
a second insulating substrate having an inner channel bounded by an inner surface of the second insulating substrate and extending along an axis from a first end to a second end thereof; and
a second resistive coil coupled to the inner surface the second insulating substrate and extending from the first end to the second of the second insulating substrate, wherein application of a voltage signal to the second resistive coil is configured to generate an electric field within the inner channel of the second insulating substrate for controlling the axial motion of ions therein,
wherein the inner channels of the first insulating substrate and the second insulating substrate are aligned so as to allow passage of ions between the inner channels of the first and second substrates.

12. The ion optical element of claim 11, further comprising a middle grid of conductive elements extending across a passageway between the inner channels of the first and second insulating substrates, and optionally, further comprising an entrance grid of conductive elements disposed adjacent the first end of the first insulating substrate, and further optionally, further comprising a mirror plate disposed adjacent the second end of the second insulating substrate.

13. A method of manufacturing an ion optical element, comprising:
forming an insulating substrate from an insulator material, the insulating substrate having an inner channel bounded by an inner surface of the insulating substrate and extending along an axis from a first end to a second end thereof; and
coupling a resistive coil to the inner surface, wherein maintaining a voltage differential across the resistive coil is configured to generate an electric field within the inner channel for controlling axial motion of ions therein.

14. The method of claim 13, wherein the resistive coil is formed on the inner surface by one of atomic layer deposition and applying a resistive ink to the inner surface of the channel.

15. The method of claim 13, further comprising forming at least one projection on the inner surface of the insulating substrate, and optionally, wherein the at least one projection is formed by removing portions of the insulating substrate.

16. The method of claim 13, wherein the insulating substrate is a first insulating substrate, the method further comprising:
coupling the first insulating substrate to a second insulating substrate having a resistive coil formed on at least a surface portion of an inner channel of the second insulating substrate, wherein the first and second insulating substrates are aligned so as to allow passage of ions between the inner channels of the first and second insulating substrates.

17. An ion optic assembly for use in a mass spectrometer, comprising:
a first ion optic extending from a proximal end to a distal end, said first ion optic having a lumen providing a first ion passageway and a first resistive trace disposed on an inner surface of the lumen, wherein flow of a current through the first resistive trace establishes a first electric field within the first ion passageway,
a second ion optic extending from a proximal end to a distal end, wherein the proximal end of the second ion optic can be coupled to the distal end of the first ion optic to form said ion optic assembly, said second ion optic further comprising a lumen providing an ion passageway and a second resistive trace disposed on an inner surface of the lumen, wherein flow of a current through said second resistive trace establishes a second electric field within the second ion passageway, and
a conductive grid positioned between said ion optics and configured to be maintained at a reference electric potential such that said first and second electric fields terminate on said conductive grid.

18. The ion optic of claim 17, further comprising a first metal coating deposited on a proximal surface of said first ion optic, a second metal coating deposited on a distal surface of said first ion optic, a third metal coating deposited on a proximal surface of said second ion optic, and a fourth metal coating deposited on a distal surface of the second ion optic.

19. The ion optic of claim 18, further comprising a first conductive tab for providing a conductive path between said first resistive trace and said first metal coating.

20. The ion optic of claim 19, further comprising a second conductive tab for providing a conductive path between said first resistive trace and said second metal coating, and optionally further comprising third conductive tab for providing a conductive path between said second resistive trace and said third metal coating.
